(19) United States
(12) Patent Application Publication
(10) Pub. No.: US 2025/0207642 A1
(43) Pub. Date: Jun. 26, 2025

(54) CENTRIFUGAL CLUTCH DEVICE

(71) Applicant: EXEDY Corporation, Osaka (JP)

(72) Inventors: Yasuaki KATAYAMA, Osaka (JP); Shinji FUTAGAWA, Osaka (JP); Takeshi WATANABE, Osaka (JP)

(21) Appl. No.: 18/960,138

(22) Filed: Nov. 26, 2024

(30) Foreign Application Priority Data
Dec. 25, 2023 (JP) 2023-217758

(51) Int. Cl. F16D 7/02; F16D 43/12; F16D 43/21

(52) U.S. Cl. CPC F16D 7/027; F16D 43/12; F16D 43/216

(57) ABSTRACT

A centrifugal clutch device includes a drive plate, a clutch outer, a clutch part, an output member, a one-way clutch, and a torque limiter. The clutch part transmits torque between the drive plate and the clutch outer in certain conditions, while being configured not to transmit torque between the drive plate and the clutch outer in other conditions. The one-way clutch is disposed between the drive plate and the clutch outer. The one-way clutch transmits torque therethrough from the clutch outer to the drive plate and does not allow transmission of torque from the drive plate to the clutch outer. The torque limiter does not transmit torque therethrough between the clutch outer and the output member when the torque has a magnitude greater than or equal to a predetermined value.

### CROSS-REFERENCE TO RELATED APPLICATIONS

This application is based on and claims the priority benefit of Japanese application 2023-217758 filed on Dec. 25, 2023, the contents of which are incorporated herein by reference.

### TECHNICAL FIELD

The claimed invention relates to a centrifugal clutch device.

### BACKGROUND

A centrifugal clutch device may be disposed between a prime mover and a drive wheel and is configured to transmit a torque when the rotational speed thereof becomes greater than or equal to a predetermined value. For example, Japan Laid-open Patent Application Publication No. 2019-196825 discloses a centrifugal clutch device that includes a drive plate, clutch shoes, and a clutch outer. When a torque, generated by the prime mover, is inputted to the centrifugal clutch device, the drive plate is rotated. Accordingly, centrifugal forces act on the clutch shoes, whereby the clutch shoes are engaged with the clutch outer. As a result, the torque, inputted to the drive plate, is transmitted to the clutch outer. The torque, transmitted to the clutch outer, is transmitted to the drive wheel through an output member.

### SUMMARY OF THE INVENTION

There is a concern that when an excessive torque is transmitted from a drive wheel side in the centrifugal clutch device configured as described above, not only the centrifugal clutch device but also another torque transmission component such as a rubber belt may be damaged.

Therefore, it is an object of embodiments of the claimed invention to prevent damage done on a torque transmission component due to transmission of an excessive torque.

A centrifugal clutch device according to a first aspect includes a drive plate, a clutch outer, a clutch part, an output member, a one-way clutch, and a torque limiter. The clutch part is configured to transmit a torque therethrough between the drive plate and the clutch outer, while being configured to prevent (i.e., not allow) transmission therethrough of the torque between the drive plate and the clutch outer. The output member is configured to output the torque toward a drive wheel. The one-way clutch is disposed between the drive plate and the clutch outer. The one-way clutch is configured to transmit the torque therethrough from the clutch outer to the drive plate and is also configured to prevent (i.e., not allow) transmission therethrough of torque from the drive plate to the clutch outer. The torque limiter is configured to prevent (i.e., not allow) transmission therethrough of torque between the clutch outer and the output member when the torque has a magnitude that is greater than or equal to a predetermined value.

According to this configuration, even if an excessive torque is inputted to the centrifugal clutch device from a drive wheel side, the torque limiter slips so as not to transmit therethrough a torque having a magnitude of greater than or equal to the predetermined value; hence, a torque transmission component can be prevented from being damaged.

A centrifugal clutch device according to a second aspect relates to the centrifugal clutch device according to the first aspect and is configured as follows. The torque limiter includes a first friction plate and a second friction plate. The first friction plate is configured to be unitarily rotated with the clutch outer. The second friction plate is configured to be unitarily rotated with the output member. The second friction plate is engaged by friction with the first friction plate.

A centrifugal clutch device according to a third aspect relates to the centrifugal clutch device according to the second aspect and is configured as follows. The clutch outer includes a first surface facing an axial direction. The output member includes a second surface facing the axial direction. The first friction plate and the second friction plate are disposed between the first surface and the second surface. The torque limiter includes an urging member. The urging member urges the first friction plate and the second friction plate such that the first friction plate and the second friction plate are pressed against each other.

A centrifugal clutch device according to a fourth aspect relates to the centrifugal clutch device according to any of the first to third aspects and is configured as follows. The clutch outer includes a first contact surface and a second contact surface. The first contact surface comes in contact with an outer peripheral surface of the output member. The second contact surface is spaced apart from the first contact surface at an interval in an axial direction. The second contact surface comes in contact with the outer peripheral surface of the output member.

A centrifugal clutch device according to a fifth aspect relates to the centrifugal clutch device according to the fourth aspect and is configured as follows. The clutch outer includes a cylindrical portion and a first protruding portion. The cylindrical portion extends in the axial direction. The first protruding portion protrudes radially inward from an inner peripheral surface of the cylindrical portion. The output member includes a shaft portion and a second protruding portion. The shaft portion extends in the axial direction. The second protruding portion protrudes radially outward from the shaft portion. The first contact surface is an inner peripheral surface of the first protruding portion. The first contact surface comes in contact with an outer peripheral surface of the shaft portion. The second contact surface is the inner peripheral surface of the cylindrical portion. The second contact surface comes in contact with an outer peripheral surface of the second protruding portion.

A centrifugal clutch device according to a sixth aspect relates to the centrifugal clutch device according to the fifth aspect and is configured as follows. The first protruding portion includes an oil pathway penetrating therethrough in the axial direction.

A centrifugal clutch device according to a seventh aspect relates to the centrifugal clutch device according to any of the first to sixth aspects and is configured as follows. The one-way clutch is disposed to overlap with the torque limiter as seen in the axial direction.

A centrifugal clutch device according to an eighth aspect relates to the centrifugal clutch device according to any of the first to seventh aspects and is configured as follows. The clutch outer includes a cover part and an attachment part. The attachment part is attached to a radially inner side of the cover part. The one-way clutch is disposed between the attachment part and the drive plate.

A centrifugal clutch device according to a ninth aspect relates to the centrifugal clutch device according to any of the first to eighth aspects and is configured as follows. The drive plate includes a first cylindrical portion extending in an axial direction. The clutch outer includes a second cylindrical portion. The second cylindrical portion extends in the axial direction. The second cylindrical portion is disposed to overlap with the first cylindrical portion as seen in a radial direction. The one-way clutch is disposed radially between the first cylindrical portion and the second cylindrical portion.

Overall, embodiments of devices according to the claimed invention make it possible to prevent damage done on a torque transmission component due to transmission of an excessive torque.

### BRIEF DESCRIPTION OF THE DRAWINGS

FIG. 1 is a cross-sectional view of an embodiment of a centrifugal clutch device in accordance with the claimed invention.

FIG. 2 is an enlarged cross-sectional view of a torque limiter.

### DETAILED DESCRIPTION

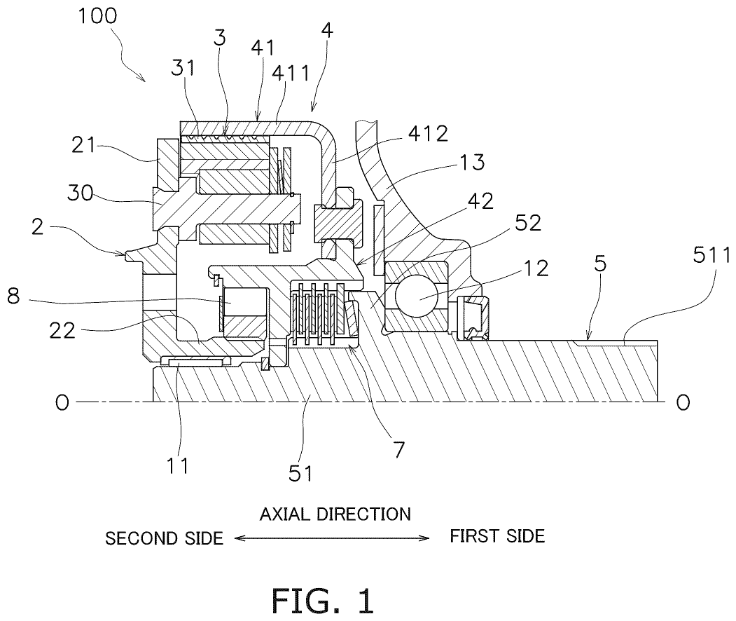

A centrifugal clutch device 100 according to the presently preferred embodiment will be hereinafter explained with reference to the drawings. FIG. 1 is a cross-sectional view of the centrifugal clutch device 100. It should be noted that in the following explanation, the term “axial direction” refers to an extending direction of a rotational axis O of the centrifugal clutch device 100. On the other hand, the term “circumferential direction” refers to a circumferential direction of an imaginary circle about the rotational axis O, whereas the term “radial direction” refers to a radial direction of the imaginary circle about the rotational axis O. Furthermore, the term “first side in the axial direction” means the right side in FIG. 1, whereas the term “second side in the axial direction” means the left side in FIG. 1.

### <Centrifugal Clutch Device>

As shown in FIG. 1, the centrifugal clutch device 100 includes a drive plate 2, a plurality of clutch shoes 3 (exemplary clutch part), a clutch outer 4, an output member 5, a torque limiter 7, and a one-way clutch 8.

The centrifugal clutch device 100 is disposed to be rotatable about the rotational axis O. The centrifugal clutch device 100 is disposed between a prime mover (omitted in the illustration) and a drive wheel (omitted in the illustration). Specifically, the centrifugal clutch device 100 may be disposed, for example, between the prime mover and a transmission (omitted in the illustration). It should be noted that the prime mover may, for instance, be an internal combustion engine. On the other hand, the transmission may, for instance, be a continuously variable transmission. In FIG. 1, the prime mover is disposed on the left side of the centrifugal clutch device 100, whereas the transmission is disposed on the right side of the centrifugal clutch device 100. The centrifugal clutch device 100 may be installed, for instance, in a motorcycle such as a buggy.

### <Drive Plate>

The drive plate 2 is disposed to be rotatable about the rotational axis O. The drive plate 2 is configured such that a torque, generated by the internal combustion engine, is inputted thereto.

The drive plate 2 includes a disc portion 21 and a first cylindrical portion 22. The disc portion 21 is made in the shape of a disc centered about the rotational axis O. An internal combustion engine-side shaft (omitted in the illustration) is configured to be attached to the disc portion 21. The first cylindrical portion 22 extends from the inner peripheral end of the disc portion 21 in the axial direction. The first cylindrical portion 22 extends from the disc portion 21 to the first side in the axial direction.

### <Clutch Shoes>

The clutch shoes 3 are pivotably attached to the drive plate 2. Each clutch shoe 3 is attached to the drive plate 2 through a pivot pin 30. Each clutch shoe 3 is pivotable about the pivot pin 30. Each clutch shoe 3 is pivotable in the radial direction.

When the drive plate 2 is rotated, a centrifugal force acts on each clutch shoe 3; accordingly, each clutch shoe 3 is pivoted such that the outer peripheral surface thereof is moved close to the inner peripheral surface of the clutch outer 4. On the other hand, when the drive plate 2 stops being rotated, the centrifugal force acting on each clutch shoe 3 disappears; accordingly, each clutch shoe 3 is pivoted by an urging force of a spring (omitted in the illustration), etc., such that the outer peripheral surface thereof is moved away from the inner peripheral surface of the clutch outer 4. It should be noted that each clutch shoe 3 is provided with a friction material 31 attached to the outer peripheral surface thereof.

When the centrifugal force acts on each clutch shoe 3, the outer peripheral surface of each clutch shoe 3 is engaged by friction with the inner peripheral surface of the clutch outer 4; accordingly, a clutch-on state is made, whereby torque is transmitted between the drive plate 2 and the clutch outer 4. On the other hand, when the centrifugal force acting on each clutch shoe 3 disappears or is reduced in magnitude, the outer peripheral surface of each clutch shoe 3 is separated from the inner peripheral surface of the clutch outer 4; accordingly, a clutch-off state is made, whereby the torque is prevented from being transmitted between the drive plate 2 and the clutch outer 4. Thus, the clutch shoes 3 are configured to transmit the torque therethrough between the drive plate 2 and the clutch outer 4, while being capable of preventing (i.e., not allowing) transmission therethrough of torque between the drive plate 2 and the clutch outer 4.

### <Clutch Outer>

The clutch outer 4 is disposed to be rotatable about the rotational axis O. The clutch outer 4 is disposed to be rotatable relative to the drive plate 2. The clutch outer 4 is disposed to cover the clutch shoes 3 from radially outside of the clutch shoes 3. The inner peripheral surface of the clutch outer 4 is radially opposed to the clutch shoes 3.

The clutch outer 4 includes a cover part 41 and an attachment part 42. The cover part 41 includes a cover body 411 and an inner flange portion 412. The cover body 411 is made in the shape of a cylinder extending in the axial direction. The cover body 411 is disposed to cover the clutch shoes 3 from radially outside of the clutch shoes 3. The inner peripheral surface of the cover body 411 is opposed to the outer peripheral surfaces of the clutch shoes 3.

The inner flange portion 412 extends radially inward from an axial end of the cover body 411. In particular, the inner flange portion 412 extends radially inward from the axially first side end of the cover body 411.

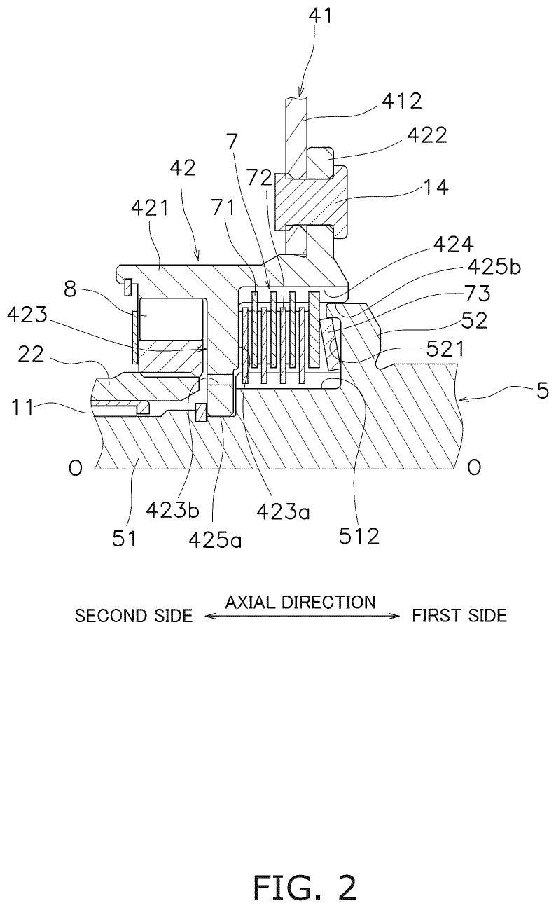

FIG. 2 is an enlarged cross-sectional view focusing on the torque limiter 7. It should be noted that FIG. 2 omits illustration of some components shown in FIG. 1 for easier understanding of the drawing. As shown in FIG. 2, the attachment part 42 is attached to the radially inner side of the cover part 41. The attachment part 42 is fixed to the cover part 41 by, for instance, rivets 14. The attachment part 42 is unitarily rotated with the cover part 41. It should be noted that the attachment part 42 may be integrated with the cover part 41 as a single member.

The attachment part 42 includes a second cylindrical portion 421, an outer flange portion 422, and a first protruding portion 423. The second cylindrical portion 421 extends in the axial direction. The outer peripheral surface of the second cylindrical portion 421 is contacted by the inner peripheral surface of the inner flange portion 412.

When radially seen, the second cylindrical portion 421 is disposed to overlap with the first cylindrical portion 22. In particular, the axially second side end of the second cylindrical portion 421 overlaps with the first cylindrical portion 22. The second cylindrical portion 421 is disposed radially outside the first cylindrical portion 22. In other words, the first cylindrical portion 22 extends inside the second cylindrical portion 421. More particularly, the distal end of the first cylindrical portion 22 extends inside the second cylindrical portion 421.

The outer flange portion 422 extends radially outwardly from the second cylindrical portion 421. More particularly, the outer flange portion 422 extends from the axially first side end of the second cylindrical portion 421. When axially seen, the outer flange portion 422 overlaps with the inner flange portion 412. The outer flange portion 422 may be fixed to the inner flange portion 412 through the rivets 14.

The first protruding portion 423 protrudes radially inwardly from the inner peripheral surface of the second cylindrical portion 421. The first protruding portion 423 has an annular shape. The first protruding portion 423 includes a first surface 423a. The first surface 423a faces the first side in the axial direction. The first surface 423a has an annular shape.

The first protruding portion 423 includes an oil pathway 423b. The oil pathway 423b penetrates the first protruding portion 423 in the axial direction. The oil pathway 423b enables communication between an installation space for the torque limiter 7 and that for the one-way clutch 8.

The second cylindrical portion 421 includes a plurality of first engaging grooves 424 on the inner peripheral surface thereof. The first engaging grooves 424 are disposed on the first side of the first protruding portion 423 in the axial direction. The first engaging grooves 424 are disposed axially between the first protruding portion 423 and a second protruding portion 52 (to be described). Each first engaging groove 424 extends in the axial direction. The first engaging grooves 424 are spaced apart from each other at intervals in the circumferential direction.

The attachment part 42 includes a first contact surface 425a and a second contact surface 425b. The first contact surface 425a is the inner peripheral surface of the first protruding portion 423. The first contact surface 425a is in contact with the outer peripheral surface of the output member 5. More particularly, the first contact surface 425a is in contact with the outer peripheral surface of a shaft portion 51 (to be described).

The second contact surface 425b is the inner peripheral surface of the second cylindrical portion 421. In particular, the second contact surface 425b is the inner peripheral surface of the axially first side end of the second cylindrical portion 421. The second contact surface 425b is spaced apart from the first contact surface 425a at an interval in the axial direction. The second contact surface 425b is disposed on the first side of the first contact surface 425a in the axial direction.

The second contact surface 425b is in contact with the outer peripheral surface of the output member 5. In particular, the second contact surface 425b is in contact with the outer peripheral surface of the second protruding portion 52 (to be described). The second contact surface 425b is disposed radially outside of the first contact surface 425a.

### <One-Way Clutch>

The one-way clutch 8 is disposed between the drive plate 2 and the clutch outer 4. When described in detail, the one-way clutch 8 is disposed between the drive plate 2 and the attachment part 42. In particular, the one-way clutch 8 is disposed radially between the first cylindrical portion 22 and the second cylindrical portion 421.

The one-way clutch 8 is disposed on the second side of the first protruding portion 423 in the axial direction. The one-way clutch 8 is disposed in a space enclosed by the first cylindrical portion 22, the second cylindrical portion 421, and the first protruding portion 423. Additionally, when axially seen, the one-way clutch 8 is disposed to overlap with the torque limiter 7.

The one-way clutch 8 is configured to transmit a torque therethrough from the clutch outer 4 to the drive plate 2. Additionally, the one-way clutch 8 is configured not to allow transmission of the torque therethrough from the drive plate 2 to the clutch outer 4.

Specifically, in such a situation that a vehicle starts moving, when the drive plate 2 is rotated at a higher speed than the clutch outer 4, the one-way clutch 8 idles. Because of this, the torque is not transmitted through the one-way clutch 8. By contrast, as seen in such a situation that the vehicle decelerates, when the clutch outer 4 is rotated at a higher speed than the drive plate 2, the torque is transmitted through the one-way clutch 8.

### <Output Member>

As shown in FIGS. 1 and 2, the output member 5 is disposed to be rotatable about the rotational axis O. The output member 5 is disposed to be rotatable relative to the drive plate 2 and the clutch outer 4. The output member 5 is configured to output the torque toward the drive wheel. For example, the output member 5 is configured to be coupled to an input shaft (omitted in illustration) of the transmission.

The output member 5 includes the shaft portion 51 and the second protruding portion 52. The shaft portion 51 extends in the axial direction. The shaft portion 51 extends inside the first cylindrical portion 22 in the axial direction. The shaft portion 51 and the first cylindrical portion 22 are disposed radially apart from each other at an interval. A needle bearing 11 is disposed between the shaft portion 51 and the first cylindrical portion 22. Additionally, the shaft portion 51 extends inside the second cylindrical portion 421 in the axial direction.

The shaft portion 51 includes at least one spline groove 511 on, for instance, the outer peripheral surface thereof. The at least one spline groove 511 is provided on the axially first side end of the shaft portion 51. An input shaft of the transmission is spline-coupled to the at least one spline groove 511. In a condition that the centrifugal clutch device 100 is installed in a vehicle, the shaft portion 51 is rotatably supported by a casing 13, etc., through a bearing member 12.

The shaft portion 51 includes a plurality of second engaging grooves 512 on a part of the outer peripheral surface thereof. The second engaging grooves 512 are provided to be radially opposed to the first engaging grooves 424 of the second cylindrical portion 421, respectively. The second engaging grooves 512 are disposed axially between the first protruding portion 423 and the second protruding portion 52.

The second protruding portion 52 protrudes radially outwardly from the shaft portion 51. The second protruding portion 52 has an annular shape. The outer peripheral surface of the second protruding portion 52 is in contact with the inner peripheral surface of the second cylindrical portion 421. In particular, the outer peripheral surface of the second protruding portion 52 is in contact with the second contact surface 425b of the attachment part 42.

When axially seen, the second protruding portion 52 overlaps with the first protruding portion 423. The second protruding portion 52 is disposed on the first side of the first protruding portion 423 in the axial direction. The second protruding portion 52 is spaced apart from the first protruding portion 423 at an interval in the axial direction. The second protruding portion 52 includes a second surface 521 facing the second side in the axial direction. In other words, the second surface 521 faces the first surface 423a. The second surface 521 has an annular shape.

### <Torque Limiter>

The torque limiter 7 is configured to prevent transmitting a torque having a magnitude of greater than or equal to a predetermined value therethrough between the clutch outer 4 and the output member 5. It should be noted that the torque limiter 7 transmits therethrough a torque having a magnitude of less than the predetermined value.

When axially seen, the torque limiter 7 overlaps with the one-way clutch 8. The torque limiter 7 is disposed on the first side of the first protruding portion 423 in the axial direction. In other words, the first protruding portion 423 is axially sandwiched by the one-way clutch 8 and the torque limiter 7. The torque limiter 7 is disposed radially between the second cylindrical portion 421 and the shaft portion 51.

The torque limiter 7 includes a plurality of first friction plates 71, a plurality of second friction plates 72, and an urging member 73. The first friction plates 71 are configured to be unitarily rotated with the clutch outer 4. Specifically, each first friction plate 71 has an annular shape. Each first friction plate 71 includes a plurality of engaging protrusions protruding radially outward from the outer peripheral end thereof. The engaging protrusions are engaged with the first engaging grooves 424, respectively. Accordingly, the first friction plates 71 are unitarily rotated with the attachment part 42. Additionally, the first friction plates 71 are axially movable with respect to the attachment part 42.

The second friction plates 72 are configured to be unitarily rotated with the output member 5. In detail, each second friction plate 72 has an annular shape. Each second friction plate 72 includes a plurality of engaging protrusions protruding radially inward from the inner peripheral end thereof. The engaging protrusions are engaged with the second engaging grooves 512, respectively. Accordingly, the second friction plates 72 are unitarily rotated with the output member 5. Additionally, the second friction plates 72 are axially movable with respect to the output member 5.

The first friction plates 71 and the second friction plates 72 are disposed between the first protruding portion 423 and the second protruding portion 52. In other words, the first friction plates 71 and the second friction plates 72 are disposed between the first surface 423a and the second surface 521.

The urging member 73 urges the first friction plates 71 and the second friction plates 72 such that the first friction plates 71 and the second friction plates 72 are pressed against each other. In detail, the urging member 73 presses the first friction plates 71 and the second friction plates 72 in the axial direction. It should be noted that in the presently preferred embodiment, the urging member 73 urges the first friction plates 71 and the second friction plates 72 toward the first surface 423a. The urging member 73 may, for instance, be a disc spring.

Each adjacent pair of first and second friction plates 71 and 72 interposes a friction material therebetween. Accordingly, in each adjacent pair of first and second friction plates 71 and 72, the first friction plate 71 is engaged by friction with the second friction plate 72 through the friction material. It should be noted that in the presently preferred embodiment, each second friction plate 72 is provided with friction materials adhered to both surfaces thereof; alternatively, each first friction plate 71 may be provided with friction materials adhered to both surfaces thereof.

When an excessive torque, having a magnitude of greater than or equal to a predetermined value, is inputted to the torque limiter 7 from the drive wheel side, the first friction plates 71 and the second friction plates 72 slip against each other, whereby the torque is not transmitted through the torque limiter 7 from the output member 5 to the attachment part 42. In other words, the output member 5 is rotated relative to the clutch outer 4. On the other hand, when a torque, having a magnitude of less than the predetermined value, is inputted to the torque limiter 7, the first friction plates 71 and the second friction plates 72 transmit the torque without slipping against each other.

### [Modifications]

One preferred embodiment of the claimed invention has been explained above. However, the claimed invention is not limited to the embodiment above, and a variety of changes can be made without departing from the scope of the claimed invention. It should be noted that respective modifications to be described below are applicable simultaneously.

(a) In the preferred embodiment described above, the torque limiter 7 is not limited in configuration to that described in the preferred embodiment described above. For example, the torque limiter 7 may not include the first friction plates 71 and the second friction plates 72. In this case, for instance, a part of the clutch outer 4 and a part of the output member 5 are configured to be engaged by friction with each other.

(b) In the preferred embodiment described above, the torque limiter 7 is configured such that the urging member 73 urges the first friction plates 71 and the second friction plates 72 to the second side in the axial direction; however, the torque limiter 7 is not limited in configuration to this. For example, the urging member 73 may urge the first friction plates 71 and the second friction plates 72 to the first side in the axial direction. In this case, the urging member 73 is disposed between the first surface 423a and the first and second friction plates 71 and 72. Besides, the first and second friction plates 71 and 72 are sandwiched by the second surface 521 and the urging member 73.

(c) In the preferred embodiment described above, the second protruding portion 52 is disposed on the first side of the first protruding portion 423 in the axial direction; alternatively, the second protruding portion 52 may be disposed on the second side of the first protruding portion 423 in the axial direction.

(d) In the preferred embodiment described above, the second cylindrical portion 421 is disposed radially outside the first cylindrical portion 22; alternatively, the second cylindrical portion 421 may be disposed radially inside the first cylindrical portion 22.

(e) In the preferred embodiment described above, the clutch shoes 3 exemplify the clutch part; however, the clutch part is not limited in configuration to this. For example, the clutch part may be composed of a clutch weight unitarily rotated with the drive plate 2, a first clutch disc unitarily rotated with the drive plate 2, and a second clutch disc unitarily rotated with the clutch outer 4. When pressed by the clutch weight, the first and second clutch discs are engaged by friction with each other, whereby the clutch-on state is made.

### LIST OF REFERENCE NUMERALS

2: Drive plate, 22: First cylindrical portion, 3: Clutch shoe, 4: Clutch outer, 41: Cover part, 42: Attachment part, 421: Second cylindrical portion, 423: First protruding portion, 423a: First surface, 423b: Oil pathway, 425a: First contact surface, 5: Output member, 51: Shaft portion, 52: Second protruding portion, 521: Second surface, 7: Torque limiter, 71: First friction plate, 72: Second friction plate, 73: Urging member, 8: One-way clutch, 100: Centrifugal clutch device

1. A centrifugal clutch device, comprising:
a drive plate;
a clutch outer;
a clutch part configured to selectively transmit a torque therethrough between the drive plate and the clutch outer, the clutch part also configured so as to not transmit the torque therethrough between the drive plate and the clutch outer;
an output member configured to output the torque toward a drive wheel;
a one-way clutch disposed between the drive plate and the clutch outer, the one-way clutch configured to selectively transmit the torque therethrough from the clutch outer to the drive plate, the one-way clutch also configured so as not to transmit the torque therethrough from the drive plate to the clutch outer; and
a torque limiter configured not to transmit the torque therethrough between the clutch outer and the output member when the torque has a magnitude greater than or equal to a predetermined value.

2. The centrifugal clutch device according to claim 1, wherein the torque limiter includes a first friction plate configured to be unitarily rotated with the clutch outer, and
a second friction plate configured to be unitarily rotated with the output member, the second friction plate engaged by friction with the first friction plate.

3. The centrifugal clutch device according to claim 2,
wherein the clutch outer includes a first surface facing an axial direction,
the output member includes a second surface facing the axial direction,
the first friction plate and the second friction plate are disposed between the first surface and the second surface, and
the torque limiter includes an urging member, the urging member urging the first friction plate and the second friction plate such that the first friction plate and the second friction plate are pressed against each other.

4. The centrifugal clutch device according to claim 1, wherein the clutch outer includes a first contact surface coming in contact with an outer peripheral surface of the output member, and
a second contact surface spaced apart from the first contact surface at an interval in an axial direction, the second contact surface coming in contact with the outer peripheral surface of the output member.

5. The centrifugal clutch device according to claim 4, wherein
the clutch outer includes a cylindrical portion and a first protruding portion, the cylindrical portion extending in the axial direction, the first protruding portion protruding radially inward from an inner peripheral surface of the cylindrical portion,
the output member includes a shaft portion and a second protruding portion, the shaft portion extending in the axial direction, the second protruding portion protruding radially outward from the shaft portion,
the first contact surface is an inner peripheral surface of the first protruding portion, the first contact surface coming in contact with an outer peripheral surface of the shaft portion, and
the second contact surface is the inner peripheral surface of the cylindrical portion, the second contact surface coming in contact with an outer peripheral surface of the second protruding portion.

6. The centrifugal clutch device according to claim 5, wherein the first protruding portion includes an oil pathway penetrating therethrough in the axial direction.

7. The centrifugal clutch device according to claim 1, wherein the one-way clutch is disposed to overlap with the torque limiter as seen in the axial direction.

8. The centrifugal clutch device according to claim 1, wherein the clutch outer includes a cover part and an attachment part, the attachment part being attached to a radially inner side of the cover part, and
the one-way clutch is disposed between the attachment part and the drive plate.

9. The centrifugal clutch device according to claim 1, wherein
the drive plate includes a first cylindrical portion extending in an axial direction,
the clutch outer includes a second cylindrical portion extending in the axial direction, the second cylindrical portion being disposed to overlap with the first cylindrical portion as seen in a radial direction, and
the one-way clutch is disposed radially between the first cylindrical portion and the second cylindrical portion.
